(19) United States
(12) Patent Application Publication
(10) Pub. No.: US 2007/0171325 A1
(43) Pub. Date: Jul. 26, 2007

(54) Light Management Film Package For Display Systems and Systems Using Same

(76) Inventors: Byung-Soo Ko, Seoul (KR); Ji-Hyung Kim, Kyonggi-Do (KR); Ji-Hwa Lee, Kyonggi-Do (KR); Byoung-Kyu Kim, Busan-City (KR)

Correspondence Address: 3M INNOVATIVE PROPERTIES COMPANY, PO BOX 33427, ST. PAUL, MN, 55133-3427, US

(21) Appl. No.: 11/275,639

(22) Filed: Jan. 20, 2006

(51) Int. Cl. G02F 1/1335

(52) U.S. Cl. 349/62

(57) ABSTRACT

An optical device such as an LCD has a package of optical films positioned between a backlight and a display panel for enhancing the optical performance of the device. The package of optical films includes a first layer and a third layer and a second layer disposed between the first and third layers. The second layer is smaller than the first layer, so that the second layer covers a first region of the first layer but not a second region of the first layer. The third layer is attached to the second region of the first layer. In some embodiments the first layer has a structured surface facing the second layer. In other embodiments, the second layer has a structured surface facing the third layer. In other embodiments, both the first and second layers have structured surfaces facing the third layer.

### FIELD OF THE INVENTION

The invention relates to optical displays, and more particularly to display systems that are illuminated from behind, such as may be used in LCD monitors and LCD televisions.

### BACKGROUND

Liquid crystal displays (LCDs) are optical displays used in devices such as laptop computers, hand-held calculators, digital watches and televisions. Some LCDs include a light source that is located to the side of the display, with a light guide positioned to guide the light from the light source to the back of the LCD panel. Other LCDs, for example some LCD monitors and LCD televisions (LCD-TVs), are directly illuminated using a number of light sources positioned behind the LCD panel. This arrangement is increasingly common with larger displays, because the light power requirements, to achieve a certain level of display brightness, increase with the square of the display size, whereas the space available for locating light sources along the side of the display only increases linearly with display size. In addition, some LCD applications, such as LCD-TVs, require that the display be bright enough to be viewed from a greater distance than other applications, and the viewing angle requirements for LCD-TVs are generally different from those for LCD monitors and hand-held devices.

Some LCD monitors and most LCD-TVs are commonly illuminated from behind by a number of cold cathode fluorescent lamps (CCFLs). In some arrangements, the lamps are positioned directly behind the display and in other arrangements, the lamps are positioned to the side of the display and the light is guided from the lamps to a position behind the display using a light guide.

Different light management films are positioned between the light sources, or light guide, and the display unit, to enhance the throughput of light. For example, a display may use a diffuser film and a prismatic brightness film. The display system is often manufactured by stripping a protective layer off each side of the optical films and then laying each of these films individually over a support plate. This is a labor intensive process and requires care to prevent damaging the surface of the films.

### SUMMARY OF THE INVENTION

One embodiment of the invention is directed to an optical device that has a package of optical films. The package of optical films includes a first layer and a third layer and a second layer disposed between the first and third layers. The second layer is sized such that the second layer is disposed over a first region of the first layer but not disposed over a second region of the first layer. The third layer is attached to the second region of the first layer. In some embodiments the first layer has a structured surface facing the second layer. In other embodiments, the second layer has a structured surface facing the third layer. In other embodiments, the first layer has a structured surface facing the second layer first and the second layer has a structured surface facing the third layer.

These and other aspects of the present application will be apparent from the detailed description below. In no event, however, should the above summaries be construed as limitations on the claimed subject matter, which subject matter is defined solely by the attached claims, as may be amended during prosecution.

### BRIEF DESCRIPTION OF THE DRAWINGS

The invention may be more completely understood in consideration of the following detailed description in connection with the accompanying drawings, in which like reference numerals designate like elements, and wherein:

FIG. 1 schematically illustrates a display device that uses an arrangement of light management films;

FIG. 2 schematically illustrates a light management film package;

FIGS. 3A-3E schematically illustrate different exemplary embodiments of a light management film package;

FIGS. 4A and 4B schematically illustrate different views of an exemplary light management film package;

FIG. 5 schematically illustrates an embodiment of a light management film package;

FIGS. 6A-6E schematically illustrate different exemplary embodiments of a light management film package;

FIGS. 7A and 7B schematically illustrate an approach for manufacturing light management film packages;

FIG. 8 schematically illustrates another approach for manufacturing light management film packages; and

FIGS. 9A-9C schematically illustrate plan, or front, views of different light management film packages.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives failing within the spirit and scope of the invention as defined by the appended claims.

### DETAILED DESCRIPTION

The present invention is applicable to liquid crystal displays (LCDs, or LC displays), and is applicable to LCDs that are directly illuminated from behind and to LCDs that are edge lit, for example, those used in LCD monitors and LCD televisions (LCD-TVs).

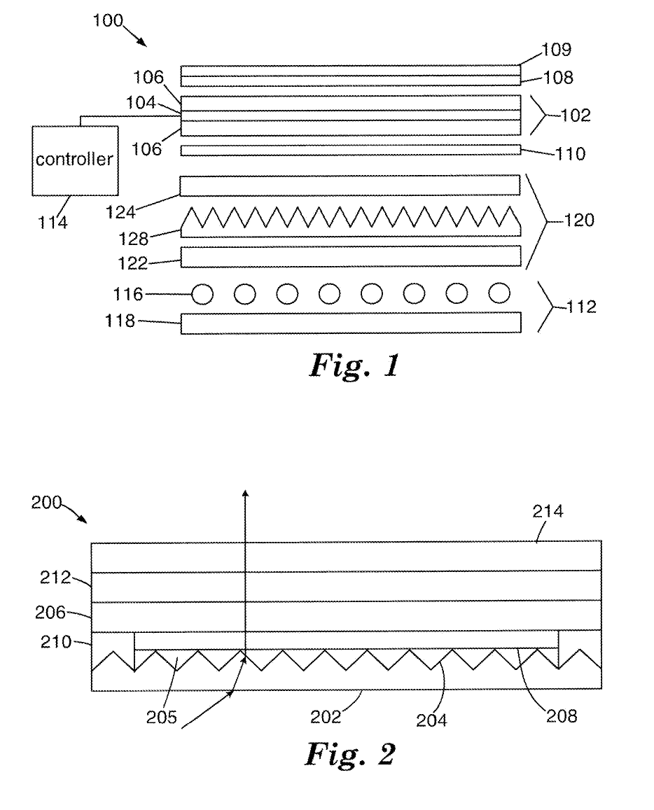

A schematic exploded view of an exemplary embodiment of a direct-lit LC display device 100 is presented in FIG. 1. Such a display device 100 may be used, for example, in an LCD monitor or LCD-TV. The display device 100 is based on the use of an LC panel 102, which typically comprises a layer of LC 104 disposed between panel plates 106. The plates 106 are often formed of glass, and may include electrode structures and alignment layers on their inner surfaces for controlling the orientation of the liquid crystals in the LC layer 104. The electrode structures are commonly arranged so as to define LC panel pixels, areas of the LC layer where the orientation of the liquid crystals can be controlled independently of adjacent areas. A color filter may also be included with one or more of the plates 106 for imposing color on the image displayed.

An upper absorbing polarizer 108 is positioned above the LC layer 104 and a lower absorbing polarizer 110 is positioned below the LC layer 104. In the illustrated embodiment, the upper and lower absorbing polarizers are located outside the LC panel 102. The absorbing polarizers 108, 110 and the LC panel 102 in combination control the transmission of light from the backlight 112 through the display 100 to the viewer. In some LC displays, the absorbing polarizers 108, 110 may be arranged with their transmission axes perpendicular. When a pixel of the LC layer 104 is not activated, it may not change the polarization of light passing therethrough. Accordingly, light that passes through the lower absorbing polarizer 110 is absorbed by the upper absorbing polarizer 108, when the absorbing polarizers 108, 110 are aligned perpendicularly. When the pixel is activated, on the other hand, the polarization of the light passing therethrough is rotated, so that at least some of the light that is transmitted through the lower absorbing polarizer 110 is also transmitted through the upper absorbing polarizer 108. Selective activation of the different pixels of the LC layer 104, for example by a controller 114, results in the light passing out of the display at certain desired locations, thus forming an image seen by the viewer. The controller may include, for example, a computer or a television controller that receives and displays television images. One or more optional layers 109 may be provided over the upper absorbing polarizer 108, for example to provide mechanical and/or environmental protection to the display surface. In one exemplary embodiment, the layer 109 may include a hardcoat over the absorbing polarizer 108.

It will be appreciated that some type of LC displays may operate in a manner different from that described above. For example, the absorbing polarizers may be aligned parallel and the LC panel may rotate the polarization of the light when in an unactivated state. Regardless, the basic structure of such displays remains similar to that described above.

The backlight 112 includes a number of light sources 116 that generate the light that illuminates the LC panel 102. Linear, cold cathode, fluorescent tubes that extend across the display device 100, are commonly used as the light sources 116 in the display device 100. Other types of light sources may be used, however, such as filament or arc lamps, light emitting diodes (LEDs), lasers, flat fluorescent panels or external fluorescent lamps. This list of light sources is not intended to be limiting or exhaustive, but only exemplary.

The backlight 112 may also include a reflector 118 for reflecting light propagating downwards from the light sources 116, in a direction away from the LC panel 102. The reflector 118 may also be useful for recycling light within the display device 100, as is explained below. The reflector 118 may be a specular reflector or may be a diffuse reflector. One example of a specular reflector that may be used as the reflector 118 is Vikuiti™ Enhanced Specular Reflection (ESR) film available from 3M Company, St. Paul, Minn. Examples of suitable diffuse reflectors include polymers, such as polyethylene terephthalate (PET), polycarbonate (PC), polypropylene, polystyrene and the like, loaded with diffusely reflective particles, such as titanium dioxide, barium sulphate, calcium carbonate and the like. Other examples of diffuse reflectors, including microporous materials and fibril-containing materials, are discussed in co-owned U.S. Pat. No. 6,780,355 (Kretman et al.), incorporated herein by reference.

The disclosed packages of light management layers, discussed further below, are also applicable to edge-lit display systems, in which the backlight 112 includes one or more light sources as discussed above disposed at the side of the display, with a light guide disposed beneath the LC panel 102 to guide light from the light source(s) to points behind the panel 102. Light diverting elements then direct the light that has passed along the light guide into a direction through the LC panel. A package of light management layers can be positioned between the backlight 112 and the LC panel 102.

The light management layers affect the light propagating from backlight 112 so as to improve the operation of the display device 100. For example, an arrangement 120 of light management layers may include a diffuser layer 122. The diffuser layer 122 is used to diffuse the light received from the light sources, which results in an increase in the uniformity of the illumination light incident on the LC panel 102. Consequently, this results in an image perceived by the viewer that is more uniformly bright. The diffuser layer 122 may include bulk diffusing particles distributed throughout the layer, or may include one or more surface diffusing structures, or a combination thereof.

The arrangement 120 of light management layers may also include a reflective polarizer 124. The light sources 116 typically produce unpolarized light but the lower absorbing polarizer 110 only transmits a single polarization state, and so about half of the light generated by the light sources 116 is not transmitted through to the LC layer 104. The reflective polarizer 124, however, may be used to reflect the light that would otherwise be absorbed in the lower absorbing polarizer, and so this light may be recycled by reflection between the reflective polarizer 124 and the reflector 118. At least some of the light reflected by the reflective polarizer 124 may be depolarized, and subsequently returned to the reflective polarizer 124 in a polarization state that is transmitted through the reflective polarizer 124 and the lower absorbing polarizer 110 to the LC layer 104. In this manner, the reflective polarizer 124 may be used to increase the fraction of light emitted by the light sources 116 that reaches the LC layer 104, and so the image produced by the display device 100 is brighter.

Any suitable type of reflective polarizer may be used, for example, multilayer optical film (MOF) reflective polarizers; diffusely reflective polarizing film (DRPF), such as continuous/disperse phase polarizers, wire grid reflective polarizers, or cholesteric reflective polarizers.

Both the MOF and continuous/disperse phase reflective polarizers rely on the difference in refractive index between at least two materials, usually polymeric materials, to selectively reflect light of one polarization state while transmitting light in an orthogonal polarization state. Some examples of MOF reflective polarizers are described in co-owned U.S. Pat. No. 5,882,774 (Jonza et al.), incorporated herein by reference. Commercially available examples of MOF reflective polarizers include Vikuiti™ DBEF-D200 and DBEF-D440 multilayer reflective polarizers that include diffusive surfaces, and DBEF-Q that includes relatively thick (5 or 10 mil (125 μm or 250 μm)) skin layers of polycarbonate, available from 3M Company, St. Paul, Minn.

Examples of suitable DRPF include continuous/disperse phase reflective polarizers as described in co-owned U.S. Pat. No. 5,825,543 (Ouderkirk et al.), incorporated herein by reference, and diffusely reflecting multilayer polarizers as described in e.g. co-owned U.S. Pat. No. 5,867,316 (Carlson et al.), also incorporated herein by reference. Other suitable types of DRPF are described in U.S. Pat. No. 5,751,388 (Larson).

Some examples of suitable wire grid polarizers include those described in U.S. Pat. No. 6,122,103 (Perkins et al.). Wire grid polarizers are commercially available from, inter alia, Moxtek Inc., Orem, Utah.

Some examples of suitable cholesteric polarizers include those described in, for example, U.S. Pat. No. 5,793,456 (Broer et al.), and U.S. Pat. No. 6,917,399 (Pokorney et al.). Cholesteric polarizers are often provided along with a quarter wave retarding layer on the output side, so that the light transmitted through the cholesteric polarizer is converted to linear polarization.

The arrangement 120 of light management layers may also include a brightness enhancing layer 128. A brightness enhancing layer is one that includes a surface structure that redirects off-axis light in a direction closer to the axis of the display. This increases the amount of light propagating on-axis through the LC layer 104, thus increasing the brightness of the image seen by the viewer. One example is a prismatic brightness enhancing layer, which has a number of prismatic ridges that redirect the illumination light, through a combination of refraction and reflection. Examples of prismatic brightness enhancing layers that may be used in the display device include the Vikuiti™ BEFII and BEFIII family of prismatic films available from 3M Company, St. Paul, Minn., including BEFII 90/24, BEFII 90/50, BEFIIIM 90/50, and BEFIIIT. It will be appreciated that other types of brightness enhancement films, that use brightness enhancing structures of various other shapes, may also be used. Some examples include beaded or curved shapes, and gain diffusing structures having arrays of three-dimensional structures, such as pyramids and the like.

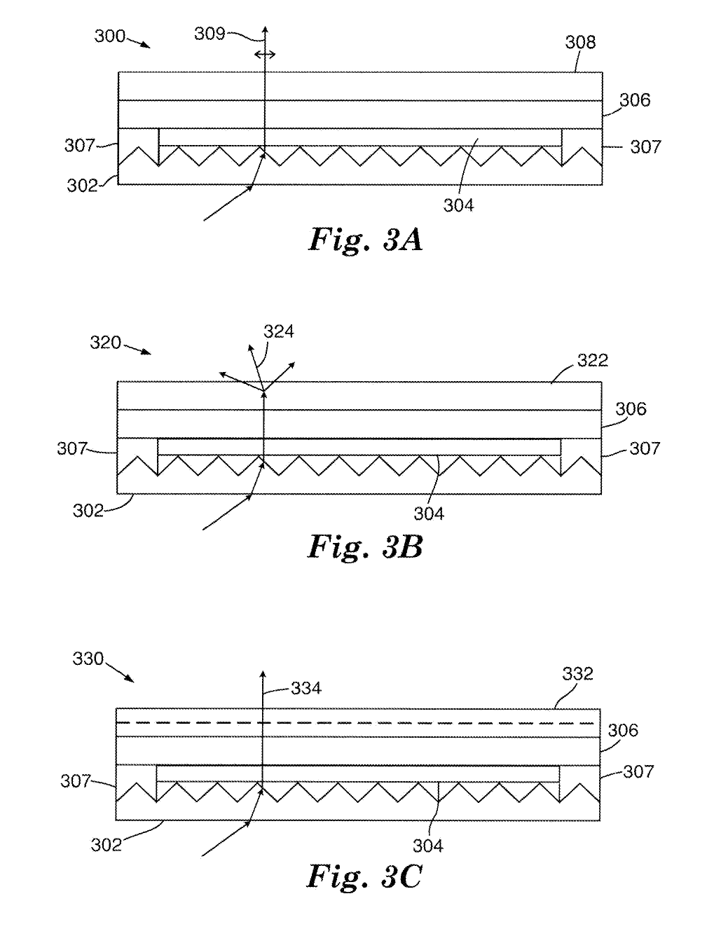

Some of the light management layers can be arranged in an integrated package where two or more layers are attached together. Such a package simplifies the assembly process for the display system, since it reduces the number of steps needed to position all the light management films behind the display unit. A cross-sectional view of one exemplary embodiment of a light management film package 200 is schematically illustrated in FIG. 2. The package 200 includes a first layer 202 having a structured surface 204. In the illustrated embodiment, the structured surface 204 is a brightness enhancing surface. Other types of structured surfaces may also be used, for example a surface diffuser layer, a Fresnel lens surface, a diffractive surface and the like. The package 200 also includes a second layer 206 and an intermediate layer 208 disposed between the first layer 202 and the second layer 206. The intermediate layer 208 is smaller in at least one lateral dimension than the first layer 202 and the second layer 206. Consequently, the intermediate layer 208 is disposed over a first region of the first layer 202 and is not disposed over a second region of the first layer 202. In the illustrated embodiment, the intermediate layer 208 is not disposed over the edge regions of the first layer 202. The second layer 206 is attached to the first layer along at least two edges via an attachment 210.

The intermediate layer 208 may be a blank layer of a transparent material, for example a transparent polymer such as poly(ethylene terephthalate) (PET), polycarbonate, polypropylene and the like. The lower surface of the intermediate layer 208 may contact portions of the structured surface 204, although due to the shape of the structured surface 204, there remain several gaps 205 between the structured surface 204 and the intermediate layer 208. In other embodiments, the intermediate layer 208 may be a reflective polarizer layer.

The second layer 206 may be an adhesive layer, for example a pressure sensitive adhesive (PSA) such as an acrylic foam tape. Some suitable examples of PSA include Optically Clear Adhesive, types 8141, 8142 and 9483, available from 3M Company, St. Paul, Minn. In some embodiments it may be desired that the light passes through the film package 200 with little or none of the light being diffused. Accordingly, the second layer 206 may have a single pass transmission of greater than 80%, or more than 90%. The single pass transmission is the amount of light that is transmitted through the layer on a single pass, and includes light that is either diffusely transmitted or specularly transmitted.

A third layer 212 may be attached to the other side of the second layer 206. For example, where the second layer 206 is an adhesive layer, the third layer 212 may be laminated to the second layer 206. The third layer 212 may be any suitable type of optical layer, for example a diffuser layer, a reflective polarizer layer, a brightness enhancing layer and the like. In some embodiments, the third layer may comprise a reflective polarizer integrated with a brightness enhancing surface. An example of such a film is Vikuiti™ BEF-RP film, manufactured by 3M Company, Minnesota.

One or more additional layers 214 may be attached to the top of third layer 212. For example, a polarizing layer, such as an absorbing polarizer or reflecting polarizer layer, or an additional brightness enhancing layer may be attached to the third layer 212. The additional layer 214 may be attached to the third layer 212 using any suitable method, for example lamination or other attachment using an adhesive.

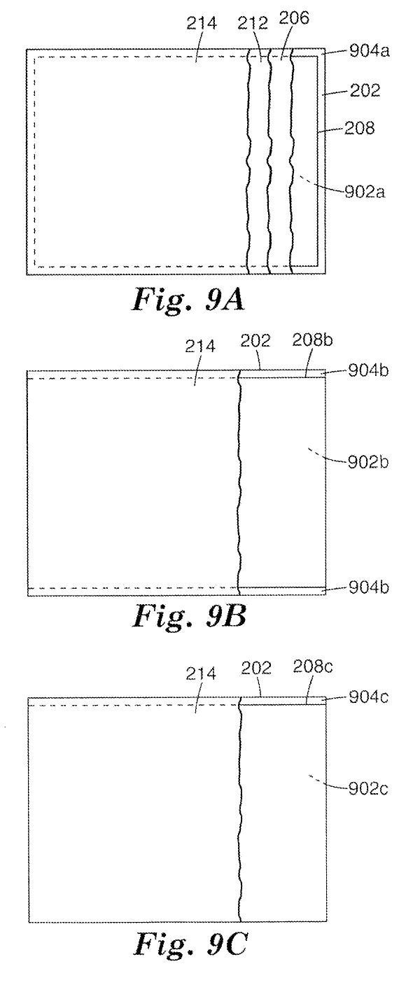

The relative lateral extent of the intermediate layer 208 and the first layer 202 is described in more detail with reference to FIGS. 9A-9C. These figures illustrate a schematic top view of the film package 200 (FIG. 9A) and similar film packages (FIGS. 9B-C), illustrating the first layer 202 and the intermediate layer (dashed lines). The intermediate layer overlies a first region of the first layer, but does not overly a second region of the first layer. The second region of the first layer attaches to a second layer such as layer 206. In FIG. 9A, the intermediate layer 208 is smaller than the first layer 202 in both height and width and so the second region 904a in this embodiment corresponds to a narrow band along the entire periphery of the first layer 202, and the first region 902a corresponds to the remainder of the first layer 202. In the alternative embodiment illustrated in FIG. 9B, intermediate layer 208 is replaced by an intermediate layer 208b that is wider than layer 208 in the horizontal direction (and substantially equal in horizontal width to first layer 202) but whose vertical width is the same as that of layer 208 (and narrower than that of layer 202). This arrangement results in a second region 904b that corresponds to narrow bands at only the top and bottom edges of the first layer 202, with the remainder of layer 202 corresponding to the first region 902b. In this embodiment, the second layer 206 is attached to the top and bottom edges of the first layer 202. In the alternative embodiment illustrated in FIG. 9C, intermediate layer 208b is replaced by an intermediate layer 208c that has the same horizontal width as intermediate layer 208b but whose vertical width is greater than that of layer 208b but still less than that of first layer 202. This arrangement results in a second region 904c corresponding to a narrow band at a single edge of the first layer 202, with the remainder of layer 202 corresponding to the first region 902c. In this embodiment, the second layer 206 is attached to the first layer 202 along one edge. Other configurations may be used. For example, the second region 904 need not extend along the entire width of any particular edge, but may be associated with only portions of an edge.

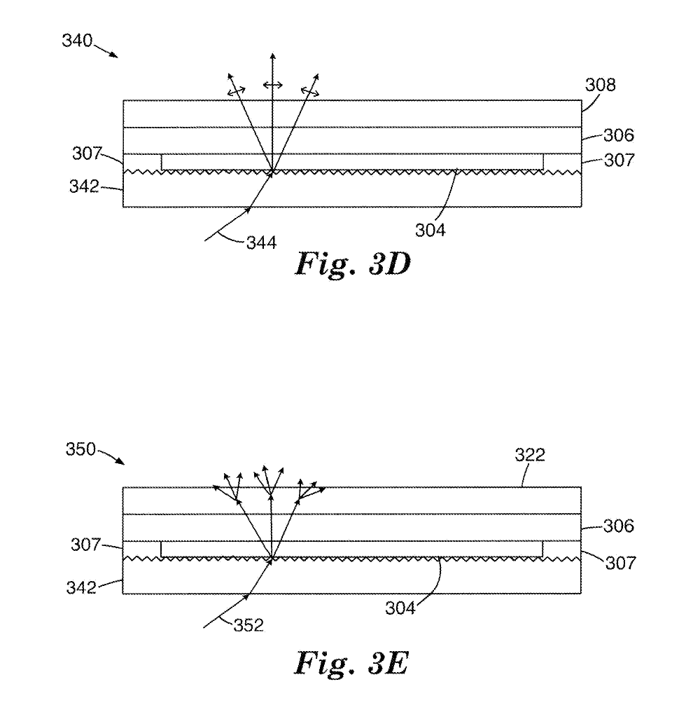

One exemplary light management film package 300 is schematically illustrated in FIG. 3A. This particular embodiment includes a brightness enhancing layer 302 below an intermediate layer 304. A pressure sensitive adhesive 306 is above the intermediate layer 304 and is attached to the brightness enhancing layer 302 along at least two edges 307. A reflective polarizer 308, such as a MOF or cholesteric polarizer, is attached to the upper side of the pressure sensitive adhesive layer. Light 309 passing through the package is directed by the brightness enhancing layer 302 and is polarized by the reflective polarizer layer 308. In the illustration, the emerging light 309 is linearly polarized.

Another exemplary light management film package 320 is schematically illustrated in FIG. 3B. In this embodiment, a diffuser layer 322 is attached to the adhesive layer 306. The light 324 is diffused upon passing through the film package 320. The intermediate layer 304 may be any suitable type of layer, for example a blank polymer layer or a reflective polarizer layer.

Another exemplary light management film package 330 is schematically illustrated in FIG. 3C. In this embodiment, a second brightness enhancing layer 332 is attached to the adhesive layer 306. The divergence of the light 334 is narrowed in a first plane by passing through the first brightness enhancing layer 302 and is narrowed in a second plane by passing through the second brightness enhancing layer 332. For example, if the package 330 were to be used in a television display, the first brightness enhancing layer 302 may narrow the divergence of the light in the vertical direction while the second brightness enhancing layer 332 narrows the divergence of the light in the horizontal direction.

Another exemplary embodiment of a light management film package 340 is schematically illustrated in FIG. 3D. In this embodiment, a surface diffuser layer 342 is positioned below the intermediate layer 304. The entire intermediate layer 304 and at least two edges 343 of the surface diffuser layer 342 are attached to the adhesive layer 306. A reflective polarizer layer 308 is attached on the other side of the adhesive layer 306. Light 344 that passes through the film package 340 is diffused by the diffuser layer 342 and is polarized by the reflective polarizer layer 308.

Another exemplary light management film package 350 is schematically illustrated in FIG. 3E. In this embodiment, a diffuser layer 322, such as a bulk diffuser layer or another surface diffuser layer or a combination of the two, is attached to the upper side of the adhesive layer 306. In this embodiment, light 352 that passes through the film package 350 is diffused both by the surface diffuser layer 342 and by the diffuser layer 322.

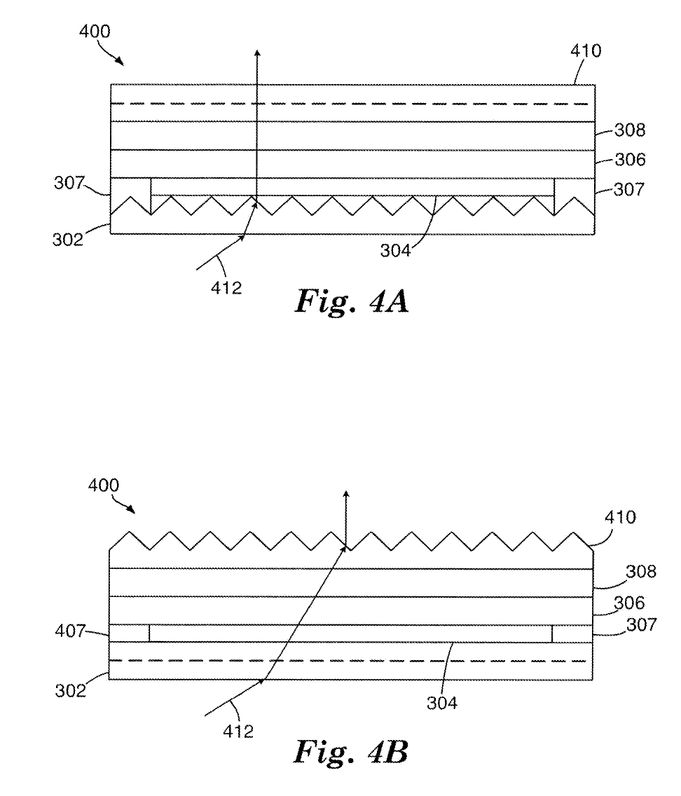

Another exemplary film package is schematically illustrated in FIGS. 4A and 4B. This film package is like that illustrated in FIG. 3A, except that a second brightness enhancing layer 410 is attached to the reflective polarizer layer 308. The second brightness enhancing layer 410 may be attached using any suitable method, for example through the use of an adhesive layer (not shown). In the film package of FIGS. 4A-B, the brightness enhancing structures of the first brightness enhancing layer 302 are shown arranged perpendicular to those of the second brightness enhancing layer 410, although other orientation angles are also contemplated. In FIG. 4A, prismatic brightness enhancing structures of the second brightness enhancing layer 410 lie parallel to the plane of the figure and prismatic brightness enhancing structures of the first brightness enhancing layer 302 lie perpendicular to the plane of the figure. In FIG. 4B, which shows the same film package but from a view at 90° to that shown in FIG. 4A, the prismatic brightness enhancing structures of the first brightness enhancing layer 302 lie parallel to the plane of the figure and the prismatic brightness enhancing structures of the second brightness enhancing layer 410 lie perpendicular to the plane of the figure.

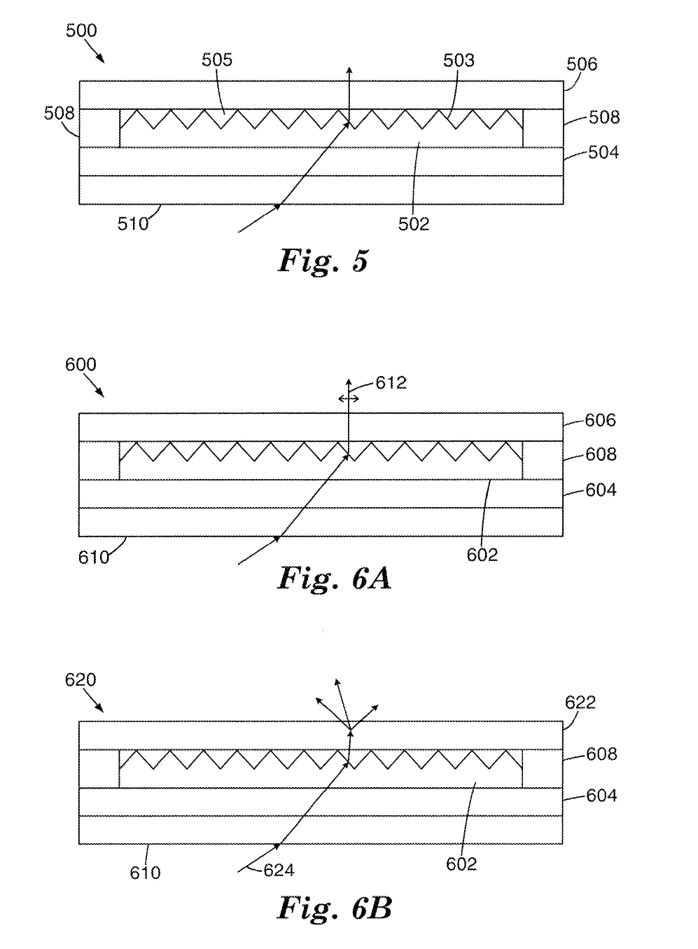

In FIG. 5, a film package 500 includes a film having a surface structure is shown sandwiched between two other layers. More particularly, a surface structured layer 502, in other words a layer having a structured surface 503, is attached to a first layer 504. In some embodiments, there is no air gap between the surface structured layer 502 and the first layer 504. The first layer 504 may be, for example, an adhesive layer such as a pressure sensitive adhesive (PSA) layer. The first layer 504 may be an acrylic foam tape, as described above. In some embodiments it may be desired that the light passes through the film package 500 with little or none of the light being diffused. Accordingly, the first layer 504 may have a single pass transmission of greater than 80%, or more than 90%.

The surface structured layer 502 does not extend laterally as far as the first layer 504, and so the surface structured layer 502 lies over a first region of the first layer 504 and does not lie over a second region of the first layer 504. In the illustrated embodiment, the second region of the first layer 504 includes the edge regions. The lateral extent of the surface structured layer 502 is less than that of its neighboring layers, in at least one direction.

A second layer 506 is disposed over the surface structured layer 502 and is attached to the second region of the first layer 504, to the edges of the first layer 504 in the illustrated embodiment. The second layer 506 is attached to the first layer 504 at attachments 508, described below. An optional base layer 510, or substrate, may be attached to the side of the first layer 504 facing away from the surface structured layer 502. The lower surface of the second layer 506 may contact portions of the structured surface 503, although due to the shape of the structured surface 503, there remain several gaps 505 between the structured surface 503 and the second layer 506.

The structured surface 503 of the surface structured layer 502 may be any desired surface structure. For example, the structured surface 503 may be a brightness enhancing surface, a surface diffuser, a Fresnel lens surface, a diffractive surface and the like.

The second layer 506 may be any desired type of layer including, for example, a reflective polarizer layer, an additional brightness enhancing layer, or a diffuser layer. In some embodiments, the second layer 506 may comprise a reflective polarizer integrated with a brightness enhancing surface. The base layer 510 may be, for example, a polymer layer that provides little or no diffusion to light passing therethrough, and may be formed of any suitable polymeric material, such as PET, polycarbonate, polypropylene and the like. It will be appreciated that the second region, where the first and second layers 504 and 506 are attached, may be around at least part of the periphery of the film package 500, for example in a manner like that shown in FIGS. 9A-9C.

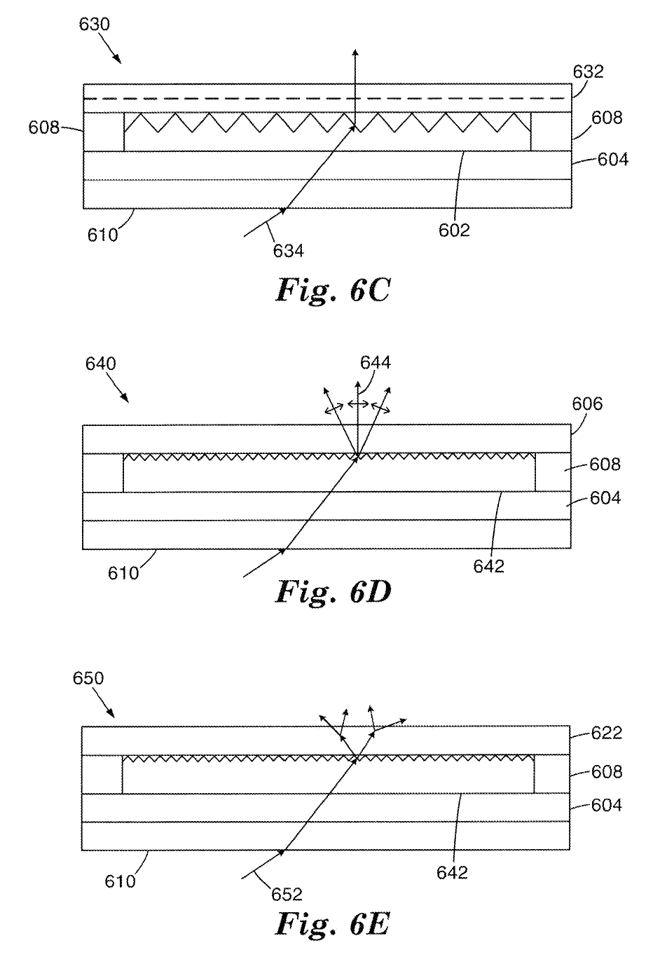

One particular embodiment of the film package described generally in FIG. 5 is schematically illustrated in FIG. 6A. In this embodiment, the film package 600 includes a brightness enhancement layer 602 disposed between an adhesive layer 604 and a reflective polarizer layer 606. The adhesive layer 604 and the reflective polarizer layer 606 are attached together along at least two edges by attachments 608. A polymer layer 610 is attached to the lower side of the adhesive layer. In this embodiment, light 612 that is transmitted through the film package 600 is redirected by the brightness enhancement layer 602 and is polarized by the reflective polarizer layer 606.

Another exemplary film package 620 is schematically illustrated in FIG. 6B. In this embodiment, a diffuser layer 622 is disposed above the brightness enhancing layer 602, so that light 624 that passes through the package 620 is redirected by the brightness enhancing layer 602 and is diffused by the diffuser layer 622.

Another exemplary film package 630 is schematically illustrated in FIG. 6C. In this embodiment, a second brightness enhancement layer 632 is disposed above the brightness enhancing layer 602. The brightness enhancing structures of the two brightness enhancement layer 602, 632 may if desired be oriented perpendicularly to each other, so that the divergence of the image light of the display is narrowed in both the horizontal and vertical directions.

Another exemplary film package 640 is schematically illustrated in FIG. 6D. This embodiment includes a surface structured layer 642 that functions as a surface diffuser layer, and is disposed below the reflective polarizer layer 606. The adhesive layer 604 and the reflective polarizer layer 606 are attached together along at least two edges by attachments 646. Thus, light 644 that passes through the package 640 is diffused by the surface diffuser layer 642 and is polarized by the polarizer layer 606.

Another exemplary film package 650 is schematically illustrated in FIG. 6E. In this embodiment, the diffuser layer 622 is positioned above the surface diffuser layer 642. Thus, light 652 that passes through the film package 650 is diffused by both the surface diffuser layer 642 and the diffuser layer 622.

In the different embodiments of film package discussed above, the attachments at the edges of the packages may be formed using an adhesive or other method of bonding. One particular approach is to employ a deformable type of adhesive layer, for example an acrylic foam tape, so that when the layer that is non-coextensive with the other layers is pressed into the deformable adhesive layer, the adhesive layer deforms, forming a recess for the non-coextensive layer. Outside the recess, the deformable adhesive layer attaches to the layer on the other side of the non-coextensive layer. For example, in the embodiment illustrated in FIG. 2, the intermediate layer 208 is the non-coextensive layer, since it does not extend laterally as far as the structured surface layer 202 or the adhesive layer 206. When the adhesive layer 206 and the structured surface layer 202 are pressed together, the adhesive layer 206 deforms, forming a recess for the intermediate layer 208 and the edges of the adhesive layer 206 not deformed by the intermediate layer 208 become attached to the structured surface layer 202. Thus, the undeformed portions of the adhesive layer 206 form the attachments 210.

Likewise, in the film package illustrated in FIG. 5, the surface structured layer 502 forms the non-coextensive layer, since it does not extend laterally as far as the adhesive layer 504 or the second layer 506. When the adhesive layer 504 and second layer 506 are pressed together, the adhesive layer 504 deforms, forming a recess for the surface structured layer 502 and the edges of the adhesive layer 504 not deformed by the surface structured layer 502 become attached to the second layer 506. Thus, the undeformed portions of the adhesive layer 504 form the attachments 508.

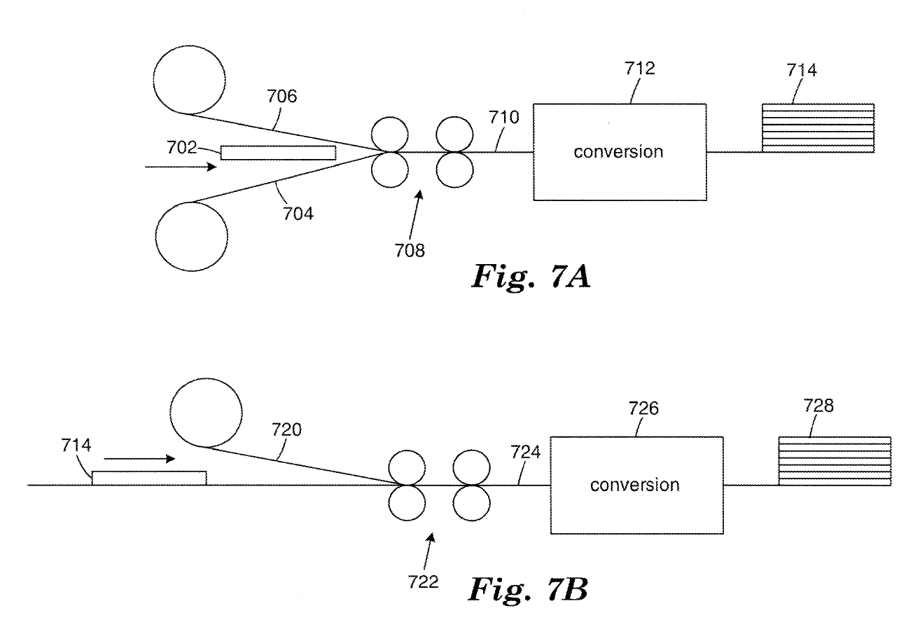

One approach to manufacturing the film packages described above is now described with reference to FIGS. 7A and 7B. The method is described in particular for manufacturing the embodiment of film package schematically illustrated in FIG. 3A, although it will be appreciated that the method may be adapted for manufacturing other embodiments of film package.

This process involves two separate steps. In the step schematically illustrated in FIG. 7A, a blank sheet 702, which will later serve as the intermediate layer, is fed between a brightness enhancing layer 704 and an adhesive layer 706, for example an acrylic foam tape. The brightness enhancing layer 704 and adhesive layer 706 are pressed together in pinch rollers 708. Where the adhesive layer 706 is deformable, the adhesive layer 706 deforms around the blank sheet 702 and attaches to selected portions of the brightness enhancing layer 704. The resulting laminate 710 is then converted at a conversion station 712, where it is cut into individual sheets 714.

In the second step, schematically illustrated in FIG. 7B, a reflective polarizer film 720 is laminated to the sheet 714 by placing the polarizer film 720 on the adhesive layer 706 and applying pressure, for example by passing the arrangement through a set of rollers 722. The resulting laminate 724 is then converted at a conversion station 726 and cut into individual sheets 728. The individual sheets 728 are suitable for use in a display, such as a television or computer monitor.

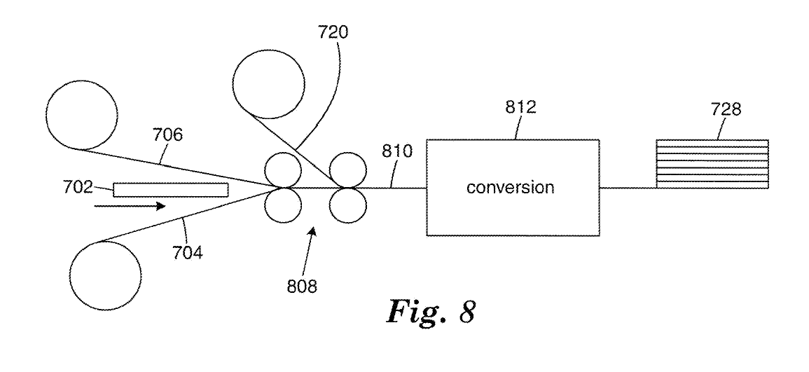

Another, single step, method for manufacturing the film package is schematically illustrated in FIG. 8. In this approach, a blank sheet 702 is fed between an adhesive layer 706 and a brightness enhancing layer 704. A reflective polarizer layer 720 is also placed on top of the adhesive layer 706 and the four layers are fed through a laminating roll 808. The pressure applied by the laminating roll 808 deforms the adhesive layer 706 so that the blank layer forms a recess in the adhesive layer 706 and portions of the adhesive layer 706 attach to the brightness enhancing layer 704. The four layer laminate 810 is fed into a conversion station 812, where it is cut into separate sheets 728.

It will be appreciated that the manufacturing methods just described may readily be adapted for manufacturing other embodiments of the invention. For example, other types of film, such as diffuser film or brightness enhancing film may be substituted for the reflective polarizer film. Also, some other type of surface structured film, such as surface diffuser film, may be substituted for the brightness enhancing layer. Furthermore, the blank sheet may be replaced by a brightness enhancing layer.

It will also be appreciated that other combinations of films, not specifically described herein, may be used in a film package that falls under the scope of the claims.

The present invention should not be considered limited to the particular examples described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the present specification. For example, free standing optical films may also be used within a display device alongside the film packages described herein. Also, a display may use more than film package. The claims are intended to cover such modifications and devices.

We claim:

1. An optical device comprising a package of optical films, the package of optical films comprising:
a first layer and a third layer; and
a second layer disposed between the first and third layers and sized such that the second layer is disposed over a first region of the first layer but not disposed over a second region of the first layer, the third layer being attached to the second region of the first layer; and
wherein the first layer has a structured surface facing the second layer, or the second layer has a structured surface facing the third layer, or both.

2. A device as recited in claim 1, wherein the first layer has the structured surface facing the second layer, the third layer being attached to the structured surface of the first layer.

3. A device as recited in claim 2, wherein the first layer comprises one of a surface diffuser layer and a brightness enhancing layer.

4. A device as recited in claim 2, wherein the second layer comprises one of a flat polymer film and a reflective polarizer.

5. A device as recited in claim 1, wherein the second layer has the structured surface facing the third layer.

6. A device as recited in claim 5, wherein the second layer comprises one of a surface diffuser layer and a brightness enhancing layer.

7. A device as recited in claim 5, wherein the second layer is attached to the first layer, there being no air gap between the first and second layers.

8. A device as recited in claim 1, wherein the second region of the first layer comprises at least a portion of the peripheral region of the first layer.

9. A device as recited in claim 1, wherein the third layer comprises an adhesive layer, the adhesive layer being attached to the second region of the first layer, a first side of the adhesive layer facing the first and second layers.

10. A device as recited in claim 9, further comprising a fourth layer attached to a second side of the adhesive layer.

11. A device as recited in claim 10, wherein the fourth layer comprises one of a reflective polarizer, a diffuser layer, a brightness enhancing layer and a reflective polarizer integrated with a brightness enhancing layer.

12. A device as recited in claim 1, wherein the third layer comprises one of a brightness enhancing layer, a diffuser layer, a reflective polarizer and a reflective polarizer integrated with a brightness enhancing surface.

13. A device as recited in claim 1, wherein the first layer comprises an adhesive layer, a first side of the adhesive layer being attached to the second layer, a second side of the adhesive layer being attached to a polymer layer.

14. A device as recited in claim 1, further comprising a display panel and a backlight unit disposed to a first side of the display panel, the backlight unit being capable of generating light that is directed to the first side of the display unit, the package of optical films being disposed between the backlight unit and the display panel.

15. A device as recited in claim 14, wherein the display panel comprises a liquid crystal display panel, the liquid crystal display panel comprising a liquid crystal layer disposed between two polarizer layers and the backlight unit comprises one or more light sources and a reflector disposed on a side of the backlight unit facing away from the display unit.

16. A device as recited in claim 14, further comprising a controller coupled to the display panel for controlling an image displayed by the display panel.
